(19) United States
(12) Patent Application Publication
(10) Pub. No.: US 2012/0131074 A1
(43) Pub. Date: May 24, 2012

(54) Contact Information Management

(75) Inventors: Kulvir Singh Bhogal, Pflugerville, TX (US); Michael Charles Hollinger, Round Rock, TX (US); Jennifer Elizabeth King, Austin, TX (US); Christina Karen Lauridsen, Austin, TX (US); Robert Ross Peterson, Austin, TX (US)

(73) Assignee: INTERNATIONAL BUSINESS MACHINES CORPORATION, Armonk, NY (US)

(21) Appl. No.: 12/952,356

(22) Filed: Nov. 23, 2010

(51) Int. Cl. G06F 17/30

(52) U.S. Cl. 707/825; 707/E17.143

(57) ABSTRACT

A method includes, with a first computing device, receiving contact information for an entity from a connector, the connector being a human operator of a peer computing device that stores a contact information database for contacts of the connector, the contact information being contact information for the entity, where the connector is providing the contact information to put an operator of the first computing device in communication with the entity, after receiving the contact information, receiving a communication with the first computing device from the entity, and in response to receiving the communication from the entity, displaying at least some of the contact information in an introduction tag along with notification of receiving the communication.

### BACKGROUND

Aspects of the present invention relate in general to contact information management, and more particularly, to methods and systems for providing users with efficient means to introduce two or more contacts.

In various social and professional settings, people often introduce their friends or acquaintances to others. For example, in a social setting, a person may wish to introduce a particular friend to another one of his or her friends. In some cases, the two friends who are introduced to each other may wish to exchange contact information. If contact information is not exchanged in person, the person who wants to contact the other person to whom he or she was introduced will have to first contact the mutual friend in order to get the contact information for the person to be contacted. When the contacting party contacts the other newly-introduced party over the phone, the other party may not recognize the number or not remember the introduction to the person trying to make contact. Consequently, the other party may not answer the call.

Similarly, in a professional setting, a person may wish to introduce a coworker to a particular client. In this case, the person will have to provide the coworker with the client's contact information. When the client is contacted by the coworker, he or she may also not recognize the number and decide not to answer the call. Even if the client was provided with the contact information for the coworker from the person making the introduction, the client may not remember receiving this contact information. Additionally, the client may not remember why the contact information was received. Furthermore, even if the client does answer the call, it may be awkward for the client if he or she does not recognize or remember the person making contact.

### BRIEF SUMMARY

A method for contact information management includes, with a first computing device, receiving contact information for an entity from a connector, the connector being a human operator of a peer computing device that stores a contact information database for contacts of the connector, the contact information received from the connector being contact information for the entity, where the connector is providing the contact information to put an operator of the first computing device in communication with the entity; after receiving the contact information with the first computing device, receiving a communication with the first computing device from the entity; and in response to receiving the communication with the first computing device from the entity, displaying at least some of the contact information in an introduction tag along with notification of receiving the communication from the entity.

A computing system includes a processor and a memory communicatively coupled to the processor. The processor is configured to receive contact information for an entity from a connector, the connector being a human operator of a peer computing device that stores a contact information database for contacts of the connector, the contact information received from the connector being contact information for the entity, where the connector is providing the contact information to put an operator of the first computing device in communication with the entity, receive a communication with the first computing device from the entity after receiving the contact information with the first computing device, and display at least some of the contact information in an introduction tag along with notification of receiving the communication from the entity in response to receiving the communication with the first computing device from the entity.

A computer program product for a mobile computing device, the computer program product includes a computer readable storage medium having computer readable code embodied therewith. The computer readable program code includes computer readable program code configured to receive contact information for an entity from a connector, the connector being a human operator of a peer computing device that stores a contact information database for contacts of the connector, the contact information received from the connector being contact information for the entity, where the connector is providing the contact information to put an operator of the first computing device in communication with the entity, computer readable program code configured to receive a communication with the first computing device from the entity after receiving the contact information with the first computing device, and computer readable program code configured to display at least some of the contact information in an introduction tag along with notification of receiving the contact from the entity in response to receiving a communication with the first computing device from the entity.

### BRIEF DESCRIPTION OF THE SEVERAL VIEWS OF THE DRAWINGS

The accompanying drawings illustrate various examples of the principles described herein and are a part of the specification. The illustrated examples are merely examples and do not limit the scope of the claims.

FIG. 1 is a diagram showing an illustrative mobile computing system, according to one example of principles described herein.

FIG. 2 is a diagram showing illustrative contact introduction, according to one example of principles described herein.

FIG. 3 is a diagram showing an illustrative user interface for a mobile computing device, according to one example of principles described herein.

FIG. 4 is a flowchart showing an illustrative method for retrieving additional metadata from secondary connector devices, according to one example of principles described herein.

FIG. 5 is a flowchart showing an illustrative method for introducing contacts, according to one example of principles described herein.

Throughout the drawings, identical reference numbers designate similar, but not necessarily identical, elements.

### DETAILED DESCRIPTION

The present specification discloses methods and systems for efficiently introducing two or more contacts to each other. In one example, a person uses a computing device such as a laptop or a mobile phone to send contact information to at least two contacts. This person will be referred to as the connector and the two people being introduced will be referred to as the first and second persons. In this example, the first person receives contact information on his or her computing device for the second person from the connector. This information may include an introduction tag to explain why the first person is receiving this contact information. This information may also be automatically placed into a database within the first person's computing device.

Additionally, the second person receives contact information for the first person. This contact information may also include an introduction tag to inform the second person of why he or she is receiving contact information for the first person. When the first person is contacted by the second person, the introduction tag can be displayed to the first person. This will remind the first person of who the second person is and possibly why the second person is contacting the first person.

Through use of methods and systems embodying principles described herein, an efficient means for introducing contacts may be realized. A person may automatically receive contact information for a second person from a trusted connector. When the second person contacts the person, the person will immediately know why he or she is being contacted and by whom. The person can then make a more informed decision as to whether or not to answer the phone call or respond to the contact accordingly.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Throughout this specification and in the appended claims, the term “entity” is to be broadly interpreted as a person, a group of people, or an organization.

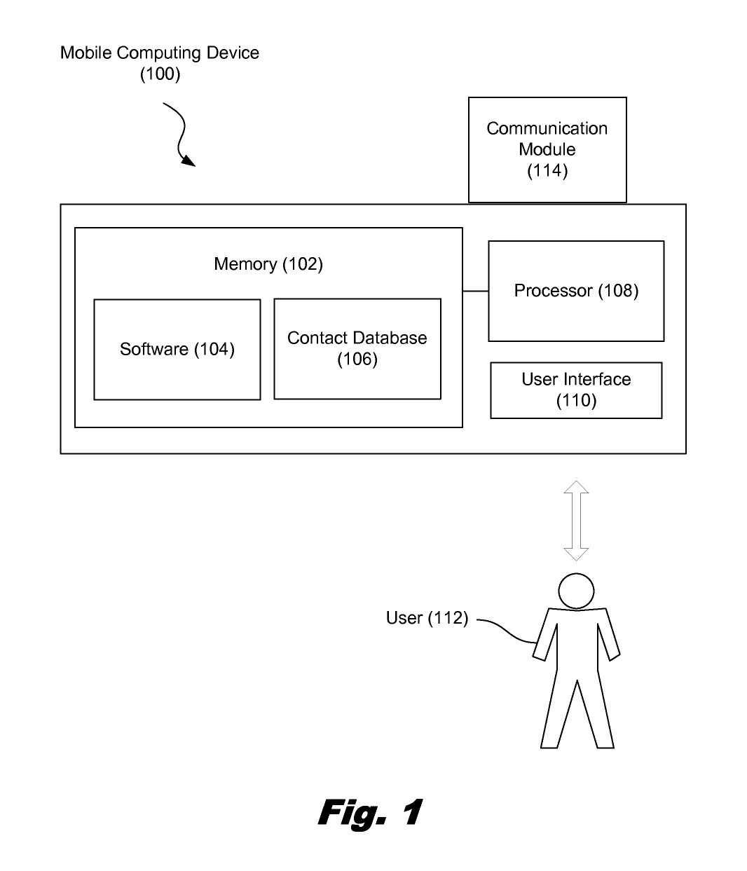

Referring now to the figures, FIG. 1 is a diagram showing an illustrative mobile computing device (100) such as a cell or mobile phone. According to certain illustrative examples, the mobile computing device (100) may include a memory (102) having software (104) and contact information (106) stored thereon.

There are many types of memory available. Some types of memory, such as solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The mobile computing system (100) also includes a processor (108) for executing the software (104) and using or updating the data (106) in the memory (102). The software (104) may include an operating system. An operating system allows other applications to interact properly with the hardware of the mobile computing system. The other applications may include a contact database which keeps a record of a user's contacts including, for example, name, phone number, email address, etc.

A user interface (110) may provide a means for the user (112) to interact with the computing system (100). The user interface may include any collection of devices for interfacing with a human user (112). For example, the user interface (110) may be a touch-screen device that acts both as a display and as an input.

The mobile computing device also includes a communication module (114). The communication module (114) provides the hardware and software that allows the mobile computing device to communicate with external equipment such as a cell-phone tower through radio waves or another communication device in close proximity through infrared signals.

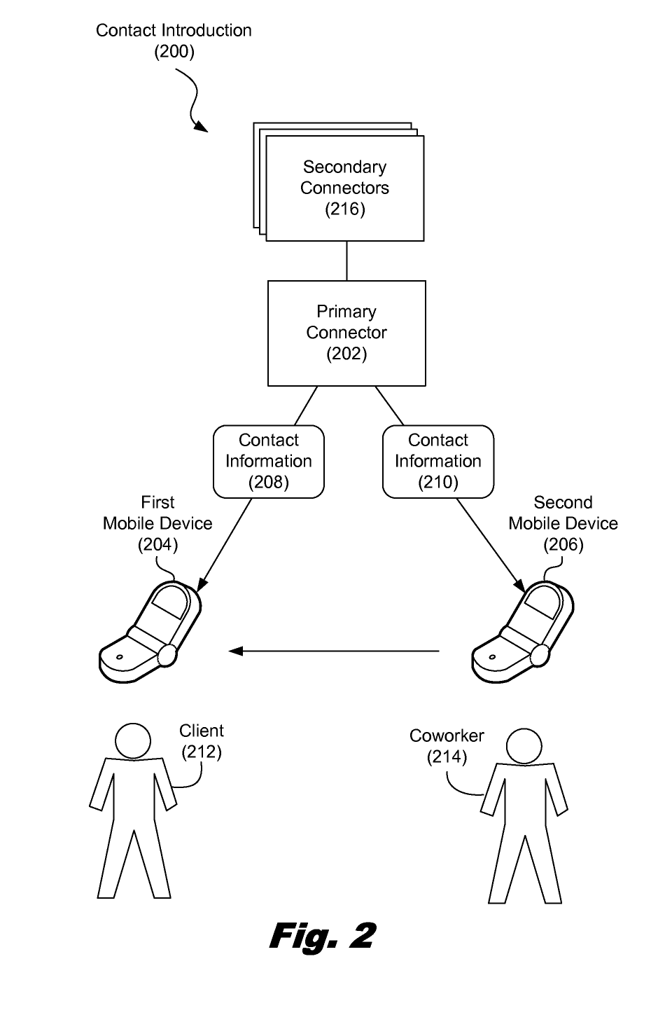

FIG. 2 is a diagram showing an illustrative contact introduction. As mentioned above, in various social and professional settings, a person may wish to introduce two of his or her friends or acquaintances to each other. For example, a person may wish to introduce a coworker to one of his or her clients. In the following example, the person wishing to introduce the client (212) and the coworker (214) to each other will be referred to as the connector (202). The client (212) will be the user of the first mobile device (204) and the coworker (214) will be the user of the second mobile device (206). While mobile devices are used in this example, it will be understood that any computing device associated with any of the three parties involved can be used to effect the introduction under the principles disclosed herein. The different computing devices used may be referred to as peer computing devices.

According to certain illustrative examples, the client (212) receives contact information (208) from the connector (202) on his or her mobile device (204). This contact information (208) includes a phone number for the coworker's (214) mobile device (206). This contact information (208) may also include an introduction tag that explains to the client (212) why he or she is receiving the coworker's (214) contact information (208). For example, the introduction tag may include information as to why the client (212) will be contacted by the coworker (214).

In addition to the client receiving contact information (208) from the connector (202), the coworker (214) also receives contact information (210) from the connector. This contact information (210) includes the phone number for the client's mobile device (204). This contact information (210) may also include an introduction tag containing information as to how, when and/or why the coworker (214) should contact the client.

Upon being contacted by the coworker (214), the client's (212) mobile device (204) may display the phone number of who is calling. Because the connector (202) has already sent the coworker's (214) contact information (208) to the client's (212) mobile device (204), the mobile device (204) can display the name of the caller, e.g., the coworker (214) to the client (212). Additionally, the introduction tag explaining to the client (212) why he or she is being contacted by the caller can be displayed as a reminder to the client (212). Thus, the client (212) can make a more informed decision as to whether or not to answer the call.

It is often the case that when a caller contacts someone from an office number, the number displayed to the call recipient is not the specific number for that person's office, but is rather a general number for the caller's organization. This is because the office phone numbers for company workers often have several similar digits but differ in the last two or three digits. For example, a person's office number may be 555-8124. However, when that person calls someone from that number, the call recipient sees a general organization phone number, such as the number 555-8000. Likewise, someone with the number 555-8026 may call someone, and the call recipient will also see the incoming call as being from the number 555-8000.

In some cases, the client (212) may be given the coworker's office number. The client (212) may also have several phone numbers in his or her mobile device's database that begin with the numbers 555-8. When the coworker (214) contacts the client (212), the client's mobile device may be unable to match the 555-8000 number with the coworker's 555-8123 number. In this case, the mobile device can be configured to match the first digits of the phone number and determine that there are a number of possible callers. In one example, the phone can display information for each of the individuals, identified as possibly being the caller.

In one illustrative example, if the client (212) does not answer the call and the coworker (214) leaves a voice message, the client's mobile device (204) will analyze the voice message and create a transcript of that message. The words in the transcript can then be analyzed and compared with the contact information for the contacts in the client's contact database. For example, if the coworker (214) leaves his or her name in the voice message, then the mobile device (204) can match the name with the contact database and inform the client (212) of who made the call.

In addition, the client (212) can be shown the contact information for the coworker (214), which may also include an introduction tag with metadata about the coworker. This metadata may remind the client (212) of why he or she was to be contacted by the coworker. This information will be useful to the client (212) when he or she returns the call of the coworker (214).

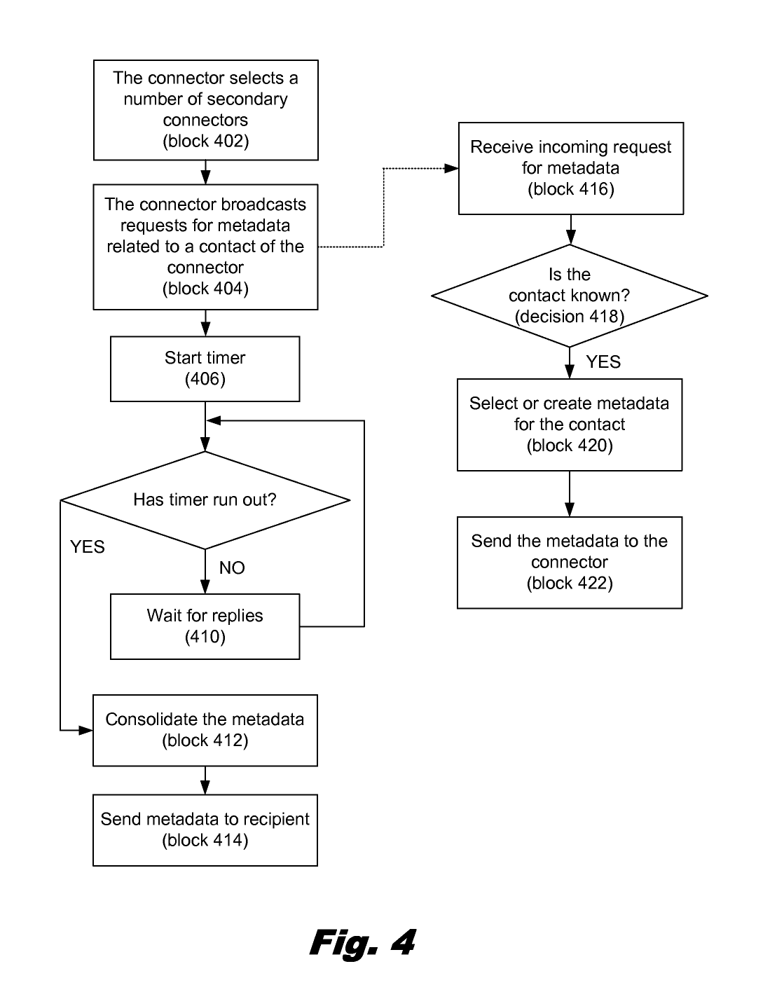

In some cases, the primary connector (202) may wish to gain more information about the contacts he or she is introducing. The primary connector (202) may request this information from a number of secondary connectors (216) using secondary peer computing devices. More details on this process will be discussed below in the text accompanying FIG. 4.

The connector may send the contact information (208, 210) from any a physical computing device such as a laptop or a mobile device. The method of transmission may be via email, text message, instant messaging, infrared signaling, radio frequency signaling or other methods for transferring data. In some cases, when the connector (202) sends the contact information (208, 210) to a mobile device (204, 206), that contact information (208, 210) may be automatically placed into the contact database of the mobile device (204, 206) or other computing device to which the contact information is sent. This may be the case if the user of the mobile device (204, 206) or other computing device has indicated that the connector is a trusted source of such information and is authorized to add contacts to the contact database of the user's computing device, e.g., mobile device (204, 206).

According to certain illustrative examples, the connector's computing device may include an application that allows that user to select two contacts from a contact database. After these contacts have been selected, the user may enter an introduction tag to be sent to each contact. A different introduction tag may be entered for each of the two contacts.

When the user indicates that he or she is done, the connecting device can automatically send to each contact, the contact information for the other of the two contacts and the introduction tag written for that contact. The contact information may be sent, for example, via a Short Message System (SMS) text message, an email message or any other means for transferring data.

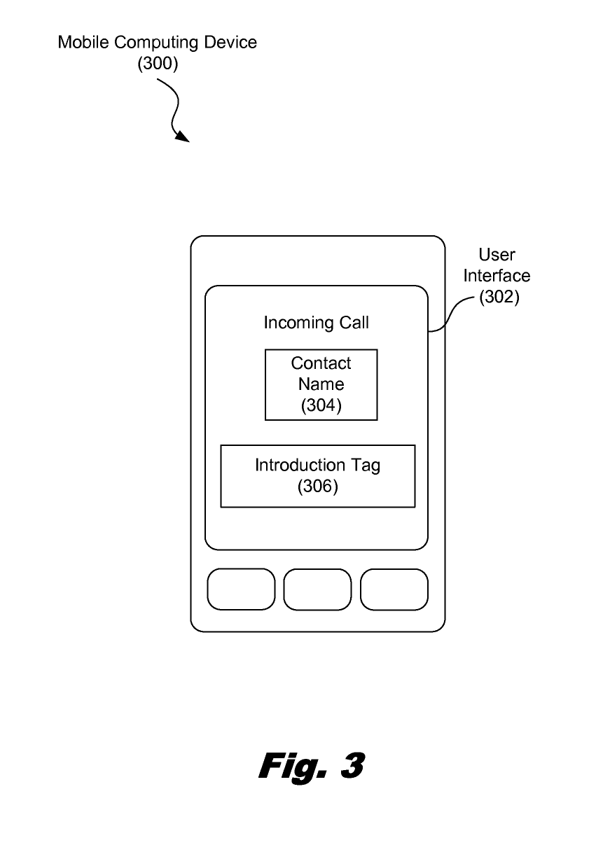

FIG. 3 is a diagram showing an illustrative user interface for a mobile computing device. According to certain illustrative examples, the mobile computing device (100) includes a touch-screen user interface (302). During an incoming call, the screen can display both the contact name (304) of the caller well as the introduction tag (306) associated with that caller.

For example, after a user has received contact information from a connector, that contact information may be placed either manually or automatically into a contact database associated with the mobile computing device (300). Upon receipt of an incoming call, the user interface can display the contact name and introduction tag (306) currently stored in the device's contact database that matched the number of the incoming phone call. For the example used in the text associated with FIG. 2, when the client receives an incoming call from the coworker, the introduction tag may say something like “this is Susan, she was going to call you regarding . . . .” The introduction tag (306) may also include more information such as the name of the connector who wrote the introduction tag (306).

The introduction tag (306) may also include additional metadata about the caller. This metadata may include, but is not limited to, information about the caller's occupation and habits. For example, the metadata may inform the call recipient what the caller's job is and how he or she can help the call recipient. The metadata may also include information for the call recipient to use when, in turn, he or she wants to contact the caller. This information may include, for example, whether the caller is likely to respond to text messages, emails etc. Additionally, the metadata may include information about the caller's schedule such as when he or she is likely to call again.

In some cases, a call recipient does not have time to review the metadata before he or she answers a call. According to certain illustrative examples, when a call recipient answers the call, the mobile device may provide an audible reminder of key information within the metadata. This reminder can be audible to the call recipient but not the caller. In one example, when a coworker contacts a client and the client answers the call, the client will hear a quiet audible reminder saying something like “This is John calling about . . . .”

FIG. 4 is a flowchart showing an illustrative method (400) for retrieving additional metadata from secondary connector devices. Secondary connector devices are the computing devices of people other than the connector who may have information about one of the two people being introduced.

According to certain illustrative examples, when the connector wants to send contact information to introduce two of his or her contacts with each other, the connector may wish to gain more information about one of those contacts. The connector may know other people who have information about one of those contacts. These other people will be referred to as secondary connectors.

The method (400) starts when the connector selects (402) potential secondary connector(s) in his or her database. The connector then transmits (block 404) requests for metadata related to a contact of the connector to the identified secondary connector(s). The connector's computing device then starts (block 406) a timer and waits (block 410) for replies from the secondary connectors. After a predetermined time, the connector's computing device will consolidate (412) the received metadata, if any, and allow the connector to decide whether to send (block 414) that metadata to the other contact being introduced.

During the predetermined time frame, while the timer is running, a secondary connector will receive (block 416) the request for metadata. The secondary connector will then determine (decision 418) whether or not the contact, who is the subject of the inquiry, is actually known, e.g., in the contact database of the secondary connector. If the contact is indeed (decision 418, YES) known, then the secondary contact can select or create (block 420) metadata for the contact and send (block 422) that metadata to the primary connector (block 422).

This process may be entirely automatic. For example, if the primary connector is identified as authorized to make such queries and receive information, the computing device of the secondary connector can receive the request and automatically return any information it its designated databases relating to the subject of the inquiry. Alternatively, the process may require that the secondary connector authorize a response to the query before any information is returned to the primary connector. In such a scenario, the secondary connector may also add additional information about the subject of the inquiry that may be helpful to the primary connector, but not currently in the contact or other database of the secondary connector.

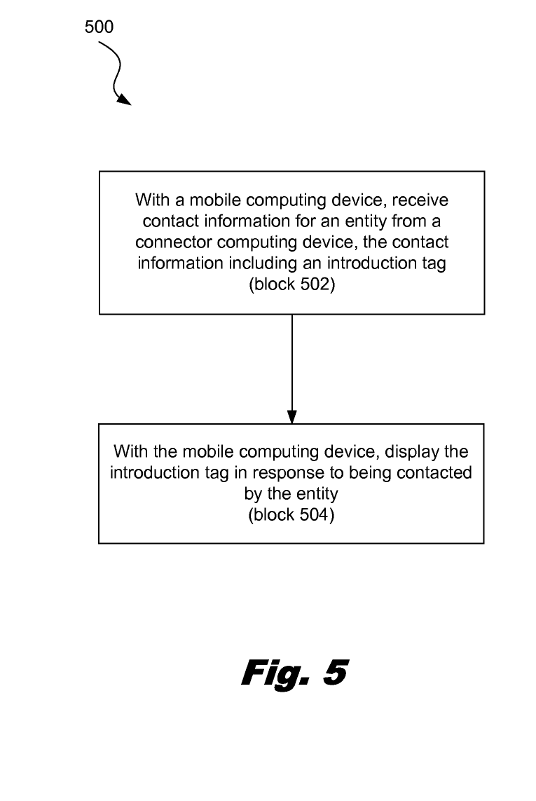

FIG. 5 is a flowchart showing an illustrative method (500) for introducing contacts. According to certain illustrative examples, the method includes, with a computing device, receiving (block 502) contact information for an entity, the contact information including an introduction tag, and with the mobile computing device, displaying (block 504) the introduction tag in response to being contacted by the entity.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for contact information management, the method comprising:
with a first computing device, receiving contact information for an entity from a connector, said connector being a human operator of a peer computing device that stores a contact information database for contacts of said connector, said contact information received from said connector being contact information for said entity, where said connector is providing said contact information to put an operator of said first computing device in communication with said entity;
after receiving said contact information with said first computing device, receiving a communication with said first computing device from said entity; and
in response to receiving said communication with said first computing device from said entity, displaying at least some of said contact information in an introduction tag along with notification of receiving said communication from said entity.

2. The method of claim 1, wherein said first computing device comprises a mobile phone.

3. The method of claim 1, wherein said entity has obtained contact information for said first computing device by said connector.

4. The method of claim 1, wherein said introduction tag includes at least some of said metadata related to said entity.

5. The method of claim 4, wherein said metadata comprises at least one of: additional contact information for said entity, occupation of said entity, and habits of said entity.

6. The method of claim 4, wherein said first computing device comprises a mobile phone and said method further comprises, with said mobile computing device, providing a user with an audible reminder of said metadata.

7. The method of claim 1, wherein said contact information includes metadata received from a plurality of secondary connectors by:
with said peer computing device, sending a request for said metadata relating to said entity to said secondary connectors; and
with said peer computing device, within a predetermined period of time, receiving said metadata from said secondary connectors.

8. The method of claim 1, wherein said peer computing device comprises an application configured to:
receive an indication of two contacts from a contact database of said connector computing device; and
automatically send contact information for said two contacts to said computing device and a second computing device of said entity.

9. The method of claim 1, wherein upon receiving said contact information, said computing device automatically places said contact into a contact database of said computing device.

10. The method of claim 9, wherein, in response to being contacted by said entity using a new device not matching said contact information, matching contact information for said new device with said received contact information based on keywords retrieved from a recorded message left by said entity.

11. A computing system comprising:
a processor; and
a memory communicatively coupled to said processor;
in which said processor is configured to:
receive contact information for an entity from a connector, said connector being a human operator of a peer computing device that stores a contact information database for contacts of said connector, said contact information received from said connector being contact information for said entity, where said connector is providing said contact information to put an operator of said first computing device in communication with said entity;
receive a communication with said first computing device from said entity after receiving said contact information with said first computing device; and
display at least some of said contact information in an introduction tag along with notification of receiving said communication from said entity in response to receiving said communication with said first computing device from said entity.

12. The system of claim 11, wherein said computing system comprises a mobile phone having said processor and memory therein.

13. The system of claim 12, wherein said introduction tag explains why the entity is contacting a user of the computing system.

14. The system of claim 12, wherein said processor is further configured to provide a user of said computing system with an audible reminder of said introduction tag.

15. The system of claim 11, wherein being contacted by said entity comprises one of: receiving a phone call, receiving an email, and receiving a text message.

16. The system of claim 11, wherein said memory comprises a database of contact information, said processor adding said contact information and introduction tag to said database.

17. The system of claim 16, wherein said processor only adds said contact information and introduction tag to said database upon acceptance by a user of the computing system.

18. A computer program product for a mobile computing device, said computer program product comprising:
a computer readable storage medium having computer readable code embodied therewith, said computer readable program code comprising:
computer readable program code configured to receive contact information for an entity from a connector, said connector being a human operator of a peer computing device that stores a contact information database for contacts of said connector, said contact information received from said connector being contact information for said entity, where said connector is providing said contact information to put an operator of said first computing device in communication with said entity;
computer readable program code configured to receive a communication with said first computing device from said entity after receiving said contact information with said first computing device; and
computer readable program code configured to display at least some of said contact information in an introduction tag along with notification of receiving said contact from said entity in response to receiving a communication with said first computing device from said entity.

19. The computer program product of claim 18, wherein said communication comprises a phone call from the entity.

20. The computer program product of claim 18, wherein said introduction tag includes metadata related to the entity.
